(19) United States
(12) Patent Application Publication
(10) Pub. No.: US 2011/0265108 A1
(43) Pub. Date: Oct. 27, 2011

(54) Disk chucking apparatus, motor and disk driving device equipped with motor

(75) Inventors: Viatcheslav Smirnov, Suwon (KR); Kyung Seob Shin, Suwon (KR); Sang Kyu Lee, Suwon (KR)

(73) Assignee: SAMSUNG ELECTRO-MECHANICS CO., LTD., Suwon (KR)

(21) Appl. No.: 12/926,232

(22) Filed: Nov. 3, 2010

(30) Foreign Application Priority Data
Apr. 23, 2010 (KR) 10-2010-0037934

(51) Int. Cl. G11B 17/028

(52) U.S. Cl. 720/704; G9B/17.006

(57) ABSTRACT

There is provided a disk chucking apparatus according to an exemplary embodiment of the present invention, including: a centering case fixed on the inner peripheral surface of a disk; and a claw formed in the centering case and including a contact unit which rotates in a horizontal direction at the time of mounting the disk and is introduced into the centering case to elastically support the inner peripheral surface of the disk.

### CROSS-REFERENCE TO RELATED APPLICATIONS

This application claims the priority of Korean Patent Application No. 10-2010-0037934 filed on Apr. 23, 2010, in the Korean Intellectual Property Office, the disclosure of which is incorporated herein by reference.

### BACKGROUND OF THE INVENTION

1. Field of the Invention

The present invention relates to a disk chucking apparatus that improves the structure of a disk claw member in order to improve the centering of a disk and chucking performance of the disk, a motor, and a disk driving device equipped with the motor.

2. Description of the Related Art

In general, a spindle motor installed in a disk driving device rotates a disk to allow optical pick-up mechanism to read data recorded in the disk.

The disk is fixed by a disk chucking apparatus which rotates together with the spindle motor and the disk is repetitively loaded onto and unloaded from the disk chucking apparatus.

The inner peripheral surface of the disk press-fits in and is mounted on the outer peripheral surface of a centering case of the disk chucking apparatus. In this case, the center of the disk should coincide with the center of the centering case in order to maintain the reliability of the recording or reproduction performance of the disk.

The centering case of the disk chucking apparatus is equipped with a chuck chip that prevents the disk from being removed after the disk is inserted onto the outer peripheral surface of the centering case and a claw supporting the inner peripheral surface of the disk is formed on the outer peripheral surface of the centering case.

The claw moves in a direction (vertical axial direction) of the disk is attached to/detached from the centering case and only force in the attachment/detachment direction of the disk is applied to the inner peripheral surface of the disk.

As a result, when the disk is repetitively attached to/detached from the centering case, stress concentrates on the claw only at the point of the attachment/detachment of the disk, such that the lift-span is shortened due to the deformation or breakage of the claw.

Further, since only the force in the attachment/detachment of the disk is applied to the inner peripheral surface of the disk, when the claw is deformed due to repetitive attachment/detachment, the disk may slip or fall out from the centering case or shakes.

In addition, when the claw is deformed, the center of the disk and the center of the centering case do not coincide with each other, causing a problem in the reliability of the recording or reproducing performance of the disk.

### SUMMARY OF THE INVENTION

An aspect of the present invention provides a disk chucking apparatus including a claw which rotatably moves in a horizontal direction inwards in an inner-diameter direction of a centering case in order to improve the centering of a disk and the chucking performance of the disk.

An aspect of the present invention also provides a motor including the disk chucking apparatus.

Another aspect of the present invention also provides a disk driving device equipped with the motor.

According to an aspect of the present invention, there is provided a disk chucking apparatus, including: a centering case fixed on the inner peripheral surface of a disk; and a claw formed in the centering case and including a contact unit which rotates in a horizontal direction at the time of mounting the disk and is introduced into the centering case to elastically support the inner peripheral surface of the disk.

The claw may include: a claw body protruding on a claw forming portion of the centering case and disposed between boundary line holes which are formed in the centering case in parallel; and a rotation rack formed by a gap hole that extends from one of the boundary line holes and cuts a part of the claw body in a direction different from the direction of the boundary line hole.

The gap hole may have a curvature in a direction opposite to the curvature of the contact unit.

The claw may be formed on the same level as a planar part of the centering case.

The claw may be formed on a level different from the planar part of the centering case.

The claw forming portion may have a polygonal shape inwards in the centering case.

The claw may include: a claw body protruding on the claw forming portion of the centering case and disposed between boundary line holes which are formed in the centering case in parallel; and a rotation rack formed by a gap hole which extends from one of the boundary line holes and cuts space between the claw forming portion and the claw body to separate the claw body from the claw forming portion.

The gap hole may have a curvature in a direction opposite to the curvature of the contact unit.

The inner surface of the centering case of the claw forming portion may have the same shape as the gap hole.

The contact unit may include a lead end contact portion of which a part protrudes outwardly in an outer-diameter direction on the boundary of the outer periphery of the centering case to contact the inner peripheral surface of the disk.

The claw body may be formed on a plane different from the planar part of the centering case and the contact unit may include the outer periphery which contacts the inner peripheral surface of the disk at the time of mounting the disk, a lead end which initially contacts the inner peripheral surface of the disk at the time of mounting the disk, and a connection portion which connects the outer periphery with the lead end, and the curvature of the lead end may be larger than that of the connection portion.

The claw may include: a claw body protruding on the claw forming portion of the centering case and disposed between the boundary line holes which are formed in the centering case in parallel; a body cut piece formed by a separation hole which cuts the claw body inwards in an inner-diameter direction in parallel with the boundary line holes; and a rotation rack formed by a gap hole which extends from the separation hole and cuts a part of the body cut piece in a direction different from the separation hole.

The gap hole may be formed towards the boundary line holes in the separation hole.

The gap hole may have a curvature in a direction opposite to the curvature of the contact unit.

The claw forming portion may have a polygonal shape inwards in the centering case.

The contact unit may include a lead end contact portion of which a part protrudes outwardly in an outer-diameter direction on the boundary of the outer peripheral surface of the centering case to contact the inner peripheral surface of the disk.

The claw may include: a claw body protruding on the claw forming portion of the centering case and disposed between the boundary line holes which are formed in the centering case in parallel; a body cut piece formed by a separation hole which cuts the claw body inwards in an inner-diameter direction in parallel with the boundary line holes; and a rotation rack formed by a separation hole which extends from at least one of the boundary line holes and cuts a part of the claw body in the direction of the separation hole of the body cut piece.

The claw forming portion may have a polygonal shape inwards in the centering case.

The gap hole may be formed along the inner surface of the claw forming portion.

The contact unit may include a lead end contact portion of which a part protrudes outwardly in an outer-diameter direction on the boundary of the outer peripheral surface of the centering case to contact the inner peripheral surface of the disk.

The claw may include: a claw body protruding on the claw forming portion of the centering case and disposed between the boundary line holes which are formed in the centering case in parallel; a body cut piece formed by a separation hole which cuts the claw body inwards in an inner-diameter direction in parallel with the boundary line holes; and a rotation rack formed by a gap hole which extends from at least one of the boundary line holes and the separation hole and cuts a part of the claw body in the direction of the separation hole and another boundary line hole.

The claw forming portion may have a polygonal shape inwards in the centering case.

The contact unit may include a lead end contact portion of which a part protrudes outwardly in an outer-diameter direction on the boundary of the outer peripheral surface of the centering case to contact the inner peripheral surface of the disk.

The claw may include: a claw body protruding on the claw forming portion of the centering case and disposed between the boundary line holes which are formed in the centering case in parallel; a body cut piece formed by a separation hole which cuts the claw body inwards in an inner-diameter direction in parallel with the boundary line holes; and a rotation rack formed by a gap hole which extends towards one of the boundary line holes in the separation hole and cuts space between the claw forming portion and the body cut piece to separate the body cut piece from the claw forming portion.

The gap hole may have a curvature in a direction opposite to the curvature of the contact unit.

The inner surface of the centering case of the claw forming portion may have the same shape as the gap hole.

The claw may include: a claw body protruding on the claw forming portion of the centering case and disposed between the boundary line holes which are formed in the centering case in parallel; a body cut piece formed by a separation hole which cuts the claw body inwards in an inner-diameter direction in parallel with the boundary line holes; and a rotation rack formed by a separation hole which extends from at least one of the boundary line holes and cuts a part of the claw body in the direction of the separation hole.

The inner surface of the centering case of the claw forming portion may have the same shape as the gap hole.

The gap hole may be formed along the inner surface of the claw forming portion.

The claw may include: a claw body protruding on the claw forming portion of the centering case and disposed between the boundary line holes which are formed in the centering case in parallel; a body cut piece formed by a separation hole which cuts the claw body inwards in an inner-diameter direction in parallel with the boundary line holes; and a rotation rack formed by a circular gap hole having a diameter larger than the width of the separation hole at an inner-diameter direction end of the separation hole.

The claw may include a claw forming portion configured by space where the contact unit is introduced into the centering case, and the contact unit may extend to form an outer diameter of the centering case at one end of the outer periphery of the centering case and may be separated from the other end of the outer periphery of the centering case corresponding to the one end.

The claw forming portion may have a polygonal shape inwards in the centering case.

The contact unit may include a lead end contact portion of which a part protrudes outwardly in an outer-diameter direction on the boundary of the outer periphery of the centering case to contact the inner peripheral surface of the disk.

The claw may include a claw forming portion configured by space where the contact unit is introduced into the centering case, and the contact unit may extend to form an outer diameter of the centering case at both ends of the outer periphery of the centering case and ends at which the contact units contact each other may be separated from each other.

The claw forming portion may have a polygonal shape inwards in the centering case.

The ends at which the contact units contact each other may include a lead end contact portion which partially protrudes outwardly in an outer-diameter direction on the boundary of the outer periphery of the centering case and contacts the inner peripheral surface of the disk.

The disk chucking apparatus may further include: a chuck chip receiving unit formed on the outer periphery of the centering case and receiving a chuck chip partially protruding outwardly in an outer-diameter direction; and a boundary wall protruding downward in the axial direction on the bottom of the centering case to allow the chuck chip receiving unit which is recessed to form a boundary.

The claw may be spaced apart from the chuck chip receiving unit with the boundary wall therebetween and may protrude on a claw forming portion having the shape of the boundary wall.

The centering case may be disposed on an axial upper part of the rotor case and may include a guide boss where a boss hole in which the outer peripheral surface of a rotor hub of the rotor case press-fits is formed.

The guide boss may protrude towards the chuck chip receiving unit and may include a boss frame where a fastening protrusion to which an elastic member elastically coupled with the chuck chip is fastened is formed.

According to another aspect of the present invention, there is provided a motor, including: a disk chucking apparatus; a rotor on which the disk chucking apparatus is seated; and a stator rotatably supporting a shaft which interworks with the rotor.

According to another aspect of the present invention, there is provided a disk driving device, including: a motor equipped with a disk; a frame equipped with the motor; an optical pick-up mechanism optically recording or reproducing the disk; and a transferring mechanism transferring the optical pick-up mechanism in a diameter direction of the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor according to an exemplary embodiment of the present invention;

FIG. 2 is a plan view of a disk chucking apparatus according to a first exemplary embodiment of the present invention;

FIG. 3 is a bottom view of a disk chucking apparatus according to a first exemplary embodiment of the present invention;

FIG. 4 is a schematic cross-sectional view illustrating a disk mounted on a disk chucking apparatus according to a first exemplary embodiment and the direction of force applied by a disk chucking apparatus after the disk is mounted;

FIG. 5 is a schematic cross-sectional view of a first modified exemplary embodiment of FIG. 4;

FIG. 6 is a schematic cross-sectional view of a second modified exemplary embodiment of FIG. 4;

FIG. 7 is a plan view illustrating the direction of force applied to a disk by a disk chucking apparatus when the disk is mounted on the disk chucking apparatus of FIG. 2;

FIG. 8 is a plan view of a disk chucking apparatus according to a second exemplary embodiment of the present invention;

FIG. 9 is a plan view of a modified example of FIG. 8;

FIG. 10 is a cross-sectional view of a claw of FIG. 8;

FIG. 11 is a plan view of a disk chucking apparatus according to a third exemplary embodiment of the present invention;

FIG. 12 is a plan view illustrating the direction of force applied to a disk by a disk chucking apparatus when the disk is mounted on the disk chucking apparatus of FIG. 11;

FIG. 13 is a plan view of a modified example of FIG. 11;

FIG. 14 is a plan view of a disk chucking apparatus according to a fourth exemplary embodiment of the present invention;

FIG. 15 is a plan view of a modified example of FIG. 14;

FIG. 16 is a plan view of a disk chucking apparatus according to a fifth exemplary embodiment of the present invention;

FIG. 17 is a plan view of a modified example of FIG. 16;

FIG. 18 is a plan view of a disk chucking apparatus according to a sixth exemplary embodiment of the present invention;

FIG. 19 is a plan view of a disk chucking apparatus according to a seventh exemplary embodiment of the present invention;

FIG. 20 is a plan view of a disk chucking apparatus according to an eighth exemplary embodiment of the present invention;

FIG. 21 is a plan view of a disk chucking apparatus according to a ninth exemplary embodiment of the present invention;

FIG. 22 is a plan view of a modified example of FIG. 21;

FIG. 23 is a plan view of a disk chucking apparatus according to a tenth exemplary embodiment of the present invention;

FIG. 24 is a plan view of a modified example of FIG. 23; and

FIG. 25 is a schematic cross-sectional view of a disk driving device according to an exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, and those are to be construed as being included in the spirit of the present invention.

Further, throughout the drawings, the same or similar reference numerals will be used to designate the same components or like components having the same functions in the scope of the similar idea.

Motor

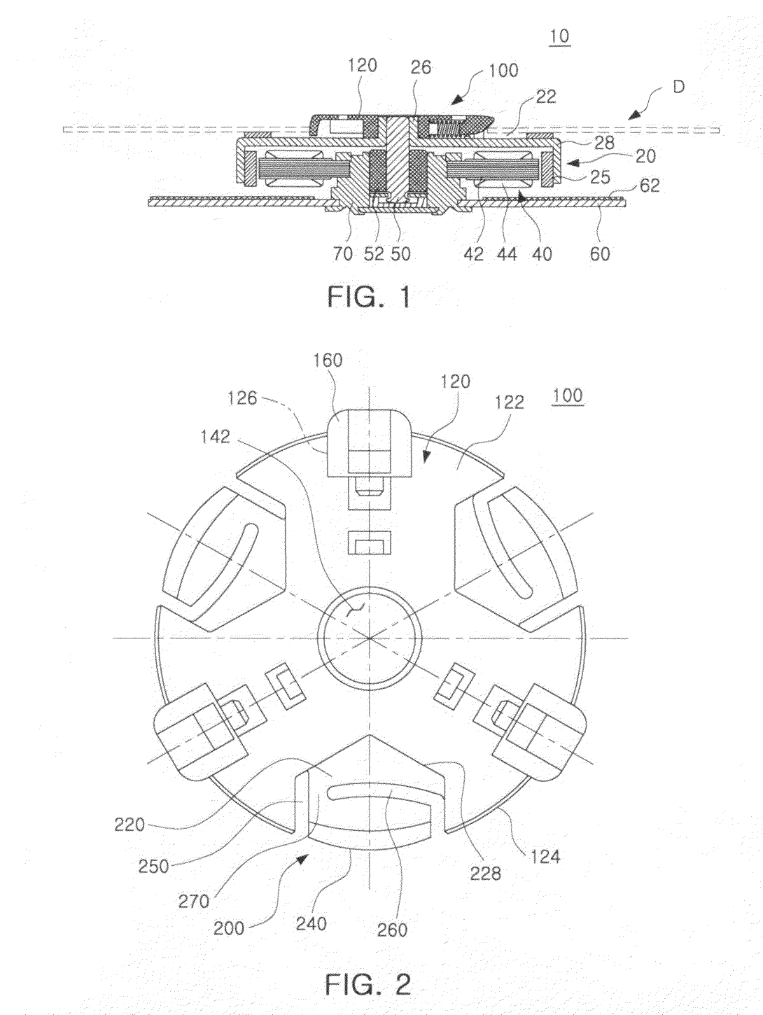

FIG. 1 is a schematic cross-sectional view of a motor according to an exemplary embodiment of the present invention.

Referring to FIG. 1, the motor 10 according to the exemplary embodiment of the present invention may include a disk chucking apparatus 100, a rotor 20, and a stator 40.

Herein, as the motor 10, a spindle motor adopted in an optical disk drive which rotates a disk D is described as an exemplary embodiment and the motor 10 is largely constituted by the rotor 20 and the stator 40.

Meanwhile, terms relating to the directions will be defined as follows. As shown in FIG. 1, an axial direction represents a vertical direction on the basis of a shaft 50 and an outer diameter direction or an inner diameter direction represents an outer end direction of the rotor 20 on the basis of the shaft 50 or a center direction of the shaft 50 on the basis of an outer end of the rotor 20.

The rotor 20 includes a cup-shaped rotor case 22 having a ring clasp type magnet 25 corresponding to a coil 44 of the stator 40 on the outer periphery thereof. The magnet 25 is a permanent magnet in which an N pole and an S pole are alternately magnetized in a circumferential direction to generate magnetic force having a predetermined strength.

The rotor case 22 includes a rotor hub 26 to which the shaft 50 is press-fastened and a magnet coupler 28 with the ring clasp type magnet 25 disposed on the inner peripheral surface thereof. The rotor hub 26 is bent upward in an axial direction in order to maintain drawing force with the shaft 50 and the disk chucking apparatus 100 on which a disk D can be loaded is mounted on the outer peripheral surface of the rotor hub 26.

The stator 40 means all fixing members excluding a rotating member and includes a base plate 60 on which a printed circuit board 62 is installed, a sleeve holder 70 press-supporting a sleeve 52 and a core 42 fixed to the sleeve holder 70, and a wiring coil 44 winding the core.

The magnet 25 provided on the inner peripheral surface of the magnet coupler 28 faces the wiring coil 44 and the rotor 20 is rotated by electromagnetic interaction between the magnet 25 and the wiring coil 44. In other words, when the rotor case 22 rotates, the shaft 50 which interworks with the rotor case 22 rotates.

By the rotation of the rotor case 22, the disk chucking apparatus 100 including a centering case 120 on which the disk D is mounted rotates together. At this time, a claw of the centering case 120 elastically supports the disk D in a horizontal direction.

Hereinafter, various exemplary embodiments of the disk chucking apparatus 100 will be described in detail.

Disk Chucking Apparatus

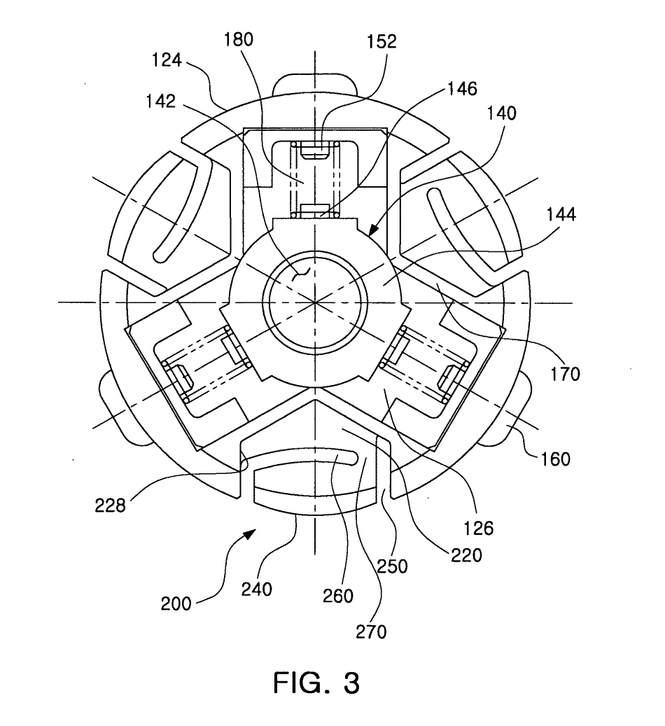

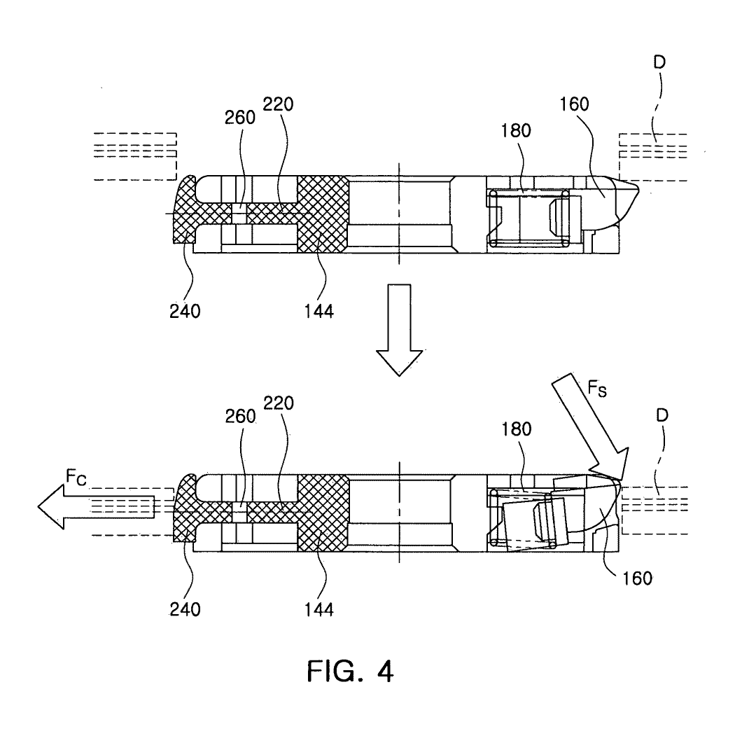

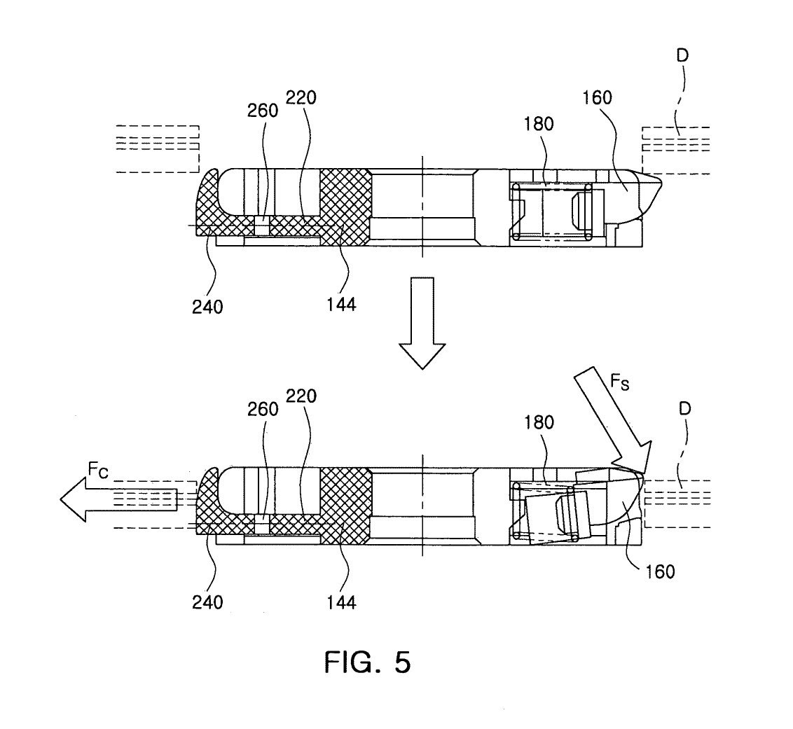

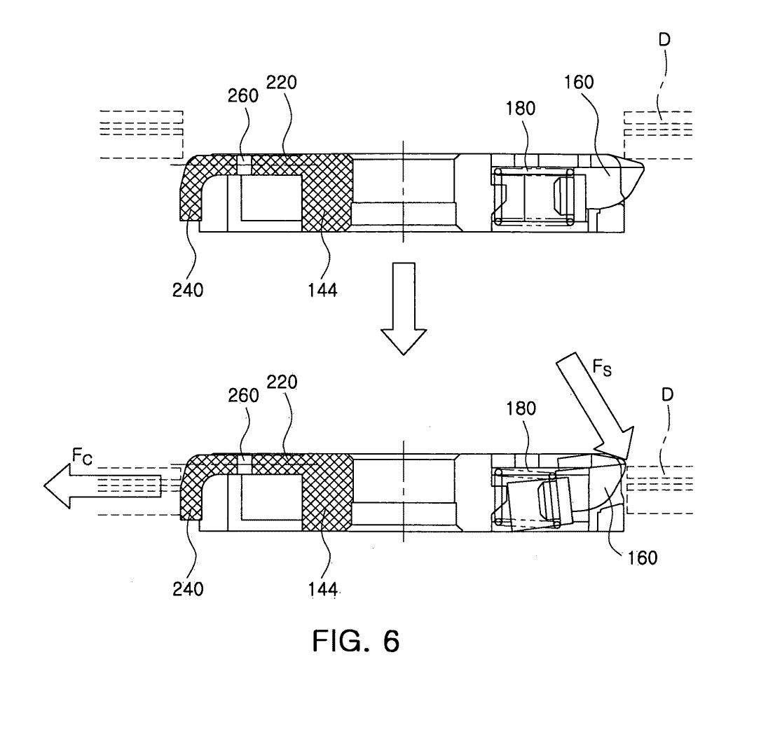

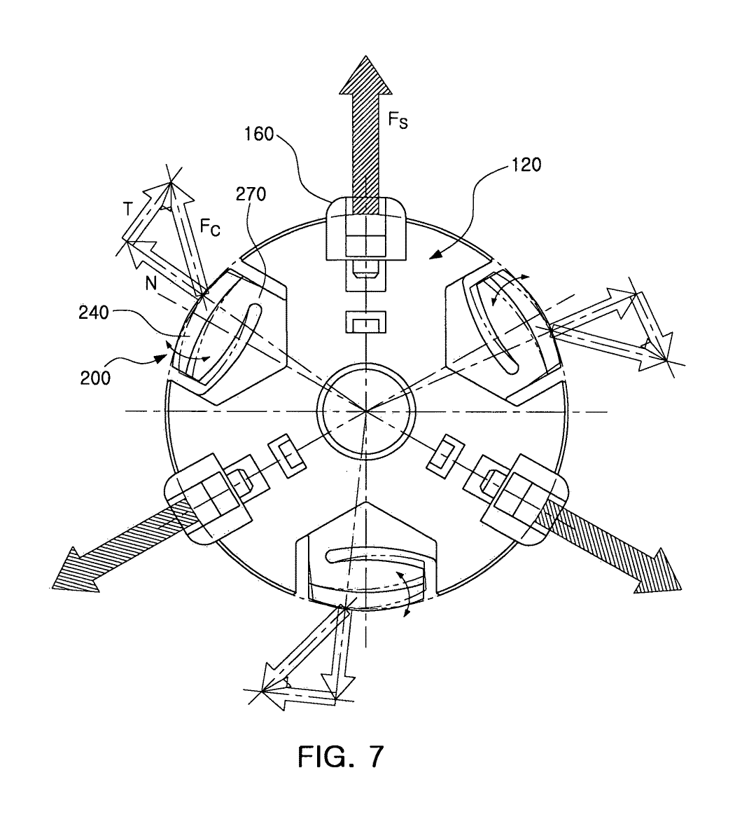

FIG. 2 is a plan view of a disk chucking apparatus according to a first exemplary embodiment of the present invention, FIG. 3 is a bottom view of a disk chucking apparatus according to a first exemplary embodiment of the present invention, FIG. 4 is a schematic cross-sectional view illustrating a disk mounted on a disk chucking apparatus according to a first exemplary embodiment and the direction of force applied by a disk chucking apparatus after the disk is mounted, FIG. 5 is a schematic cross-sectional view of a first modified exemplary embodiment of FIG. 4, FIG. 6 is a schematic cross-sectional view of a second modified exemplary embodiment of FIG. 4, and FIG. 7 is a plan view illustrating the direction of force applied to a disk by a disk chucking apparatus when the disk is mounted on the disk chucking apparatus of FIG. 2.

Referring to FIGS. 2 to 7, the disk chucking apparatus 100 according to the exemplary embodiment of the present invention may include a centering case 120 and a claw 200.

The centering case 120 includes a circular planar part 122 and an outer periphery 124 extending downward in the axial direction on an outer peripheral end of the planar part 122.

Specifically, the centering case 120 is disposed on an axial upper part of the rotor case 22 and may include a guide boss 140 where a boss hole 142 in which the outer peripheral surface of the rotor hub 26 of the rotor case 22 press-fits is formed.

Further, the inner peripheral surface of the disk D may be fixed to the outer periphery 124 of the centering case 120. A chuck chip receiving unit 126 receiving a chuck chip 160 that presses the disk D is formed in the centering case 120 in order to prevent the disk D from being removed after the disk D is mounted.

The guide boss 140 protrudes towards the chuck chip receiving unit 126 and may include a boss frame 144 where a fastening protrusion 146 to which an elastic member 180 elastically coupled with the chuck chip 160 is fastened is formed.

The chuck chip 160 may be received in the chuck chip receiving unit 126 to partially protrude outwardly in an outer direction of the outer periphery 124 of the centering case 120.

The centering case 120 may further include a boundary wall 170 that protrudes downward in the axial direction on the bottom of the centering case 120 and allows the chuck chip receiving unit 126 which is recessed to form a boundary.

The plurality of chuck chips 160 may be arranged at predetermined intervals in a circumferential direction of the centering case 120. The claw 200 is formed on the outer periphery of the centering case 120 facing the chuck chip 160. The claw 200 prevents the disk D from being removed by subsidizing the chuck chip 160 at the time of mounting the disk D.

The claw 200 may have a contact unit 240 which is introduced into the centering case 120 by rotating in the horizontal direction to elastically support the inner peripheral surface of the disk D at the time of mounting the disk D.

The claw 200 is spaced apart from the chuck chip receiving unit 126 with the boundary wall 170 therebetween and may protrude on a claw forming portion 228 having the shape of the boundary wall 170.

At this time, the claw forming portion 228 may have a polygonal shape such as the shape of the boundary wall 170 and may be bent.

The claw 200 of the exemplary embodiment protrudes on the claw forming portion 228 of the centering case 120 and may include a claw body 220 disposed between boundary line holes 250 which are formed in the centering case in parallel. Further, the claw 200 may include a rotation rack 270 formed by a gap hole 260 that extends from one of the boundary line holes 250 and cuts a part of the claw body 220 in a direction different from the direction of the boundary line hole 250.

When the disk D is mounted on the rotation rack 270, the contact unit 240 rotates horizontally in the space of the gap hole 260. At this time, after the disk D is mounted, the contact unit 240 presses the disk D in a direction opposite to the rotation direction due to elasticity of the claw 200.

The gap hole 260 may be formed in the claw body 220 to have a curvature in a direction opposite to a curvature of the contact unit 240.

Meanwhile, the gap hole 260 may protrude in an outer-diameter direction in the claw forming portion 228 of the centering case 120 of the claw body 220.

At this time, as shown in FIGS. 4 and 5, the claw 200 may be formed on the same level as the planar part 122 of the centering case 120 and as shown in FIG. 6, the claw 200 may be formed on different level from the planar part 122 of the centering case 120.

When the disk D is mounted on the centering case 120, the contact unit 240 rotates horizontally to be introduced into the inner space of the centering case 120. At this time, repelling force in the outer-diameter direction of the contact unit 240 acts on the inner peripheral surface of the disk D.

Referring to FIG. 7, force applied to the inner peripheral surface of the disk D by the claw 200 is shown.

In the claw 200, claw force Fc which is the sum of normal force N which is repelling power in a direction in which the contact unit 240 contacts the disk D and tangential force T which is rotation force in a direction opposite to a rotation and introduction direction into the inside of the centering case 120 is generated.

The tangential force T further makes the claw force Fc stronger than in the case in which only the normal force N acts, causing the disk D to be more stably supported in the centering case 120.

Meanwhile, spring force Fs is formed in the chuck chip 160 due to the repelling force of the elastic member 180.

Hereinafter, other exemplary embodiments of the claw will be described in detail and only differences from FIGS. 2 to 7 will be described.

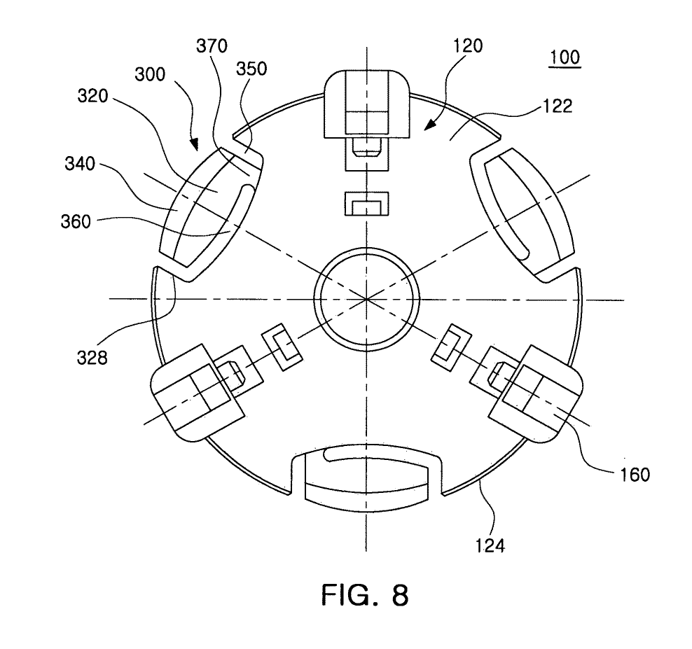

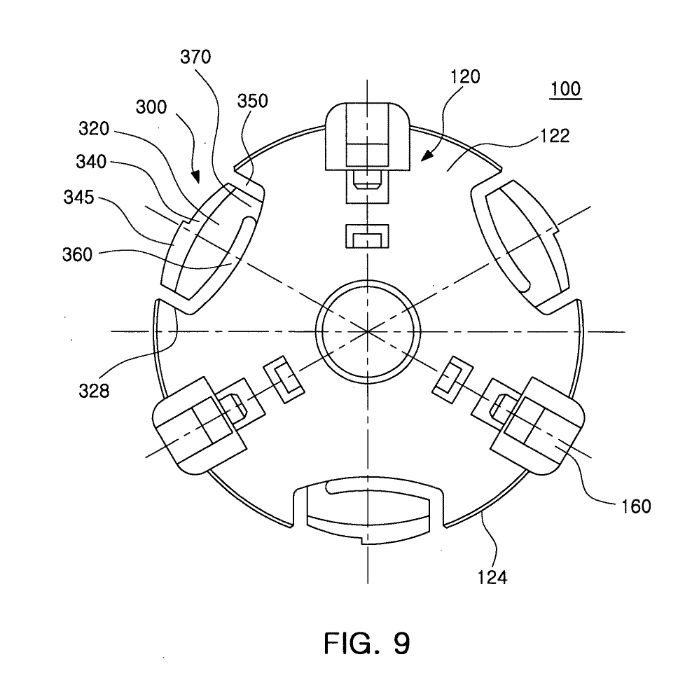

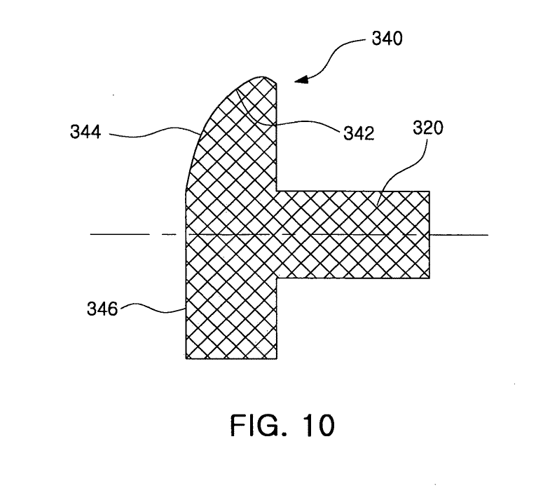

FIG. 8 is a plan view of a disk chucking apparatus according to a second exemplary embodiment of the present invention, FIG. 9 is a plan view of a modified example of FIG. 8, and FIG. 10 is a cross-sectional view of a claw of FIG. 8.

Referring to FIGS. 8 to 10, the claw 300 of the exemplary embodiment protrudes on a claw forming portion 328 of the centering case and may include a claw body 320 disposed between boundary line holes 350 which are formed in the centering case 120 in parallel.

Further, the claw 300 may include a rotation rack 370 formed by a gap hole 360 that extends from one of the boundary line holes 350 and cuts space between the claw forming portion 328 and the claw body 320 to separate the claw forming portion 328 and the claw body 320 from each other.

Herein, the gap hole 360 may have a curvature in an opposite direction to the curvature of a contact unit 340.

The inner surface of the centering case 120 of the claw forming portion 328 may have the same shape as the gap hole 360.

As shown in FIG. 9, the contact unit 340 may have a lead-end contact portion 345 of which a part protrudes outwardly in an outer-diameter direction on the boundary of the outer periphery 124 of the centering case 120 to contact the inner peripheral surface of the disk D.

Since the lead-end contact portion 345 makes the rotation force of the contact unit 340 stronger, the claw force Fc may be generally increased by increasing the strength of the tangential force T which is one of component forces of the claw force Fc.

At this time, the claw body 320 may be formed on a plane different from the planar part 122 of the centering case 120.

In addition, as shown in FIG. 10, the contact unit 340 may include an outer periphery 346 which contacts the inner peripheral surface of the disk at the time of mounting the disk D, a lead end portion 342 that initially contacts the inner peripheral surface of the disk at the time of mounting the disk, and a connection portion 344 which connects the outer periphery 346 with the lead end portion 342.

Herein, the curvature of the lead end portion 342 is larger than that of the connection portion 344 to softly mount the disk D.

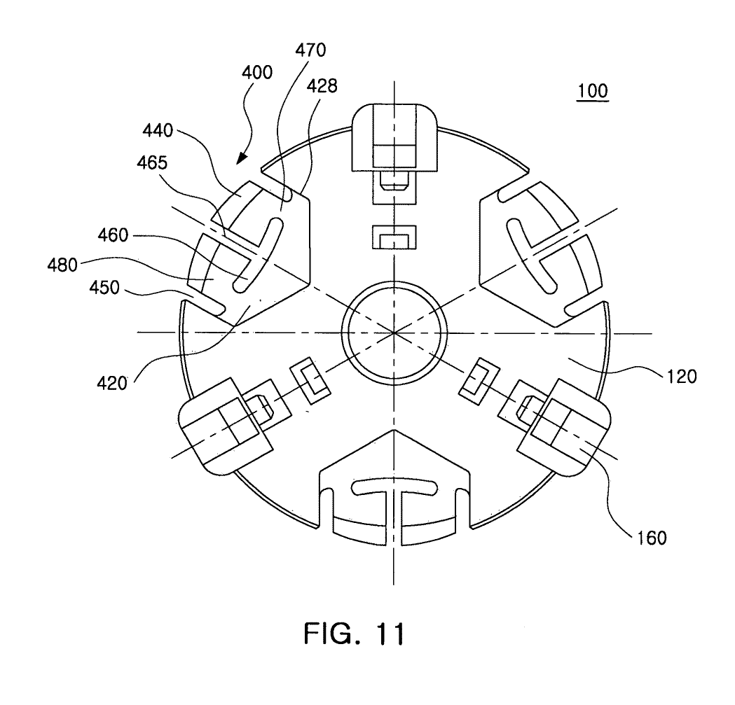

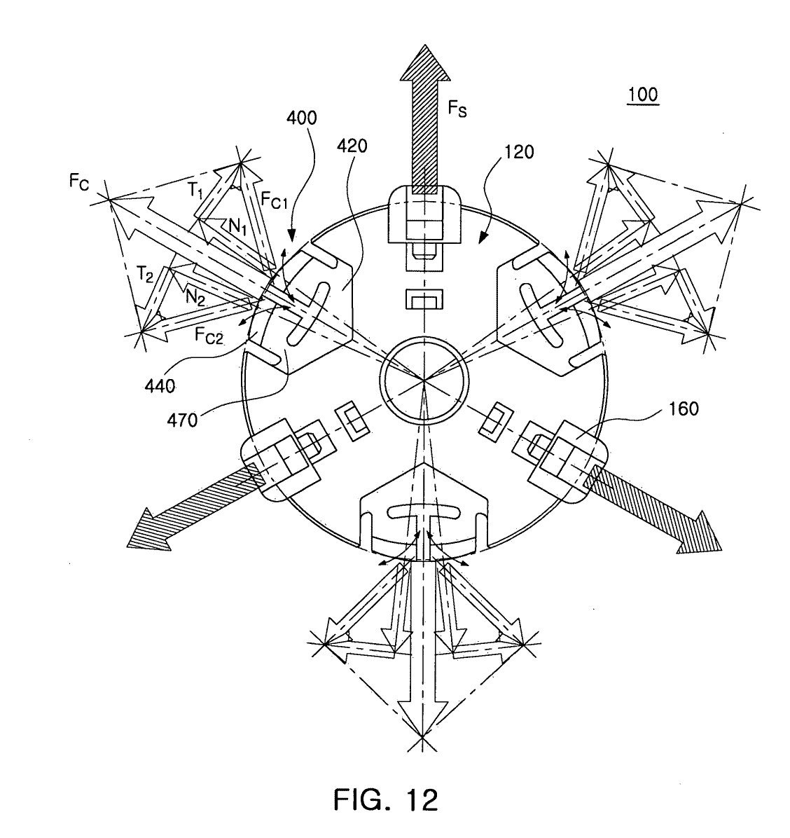

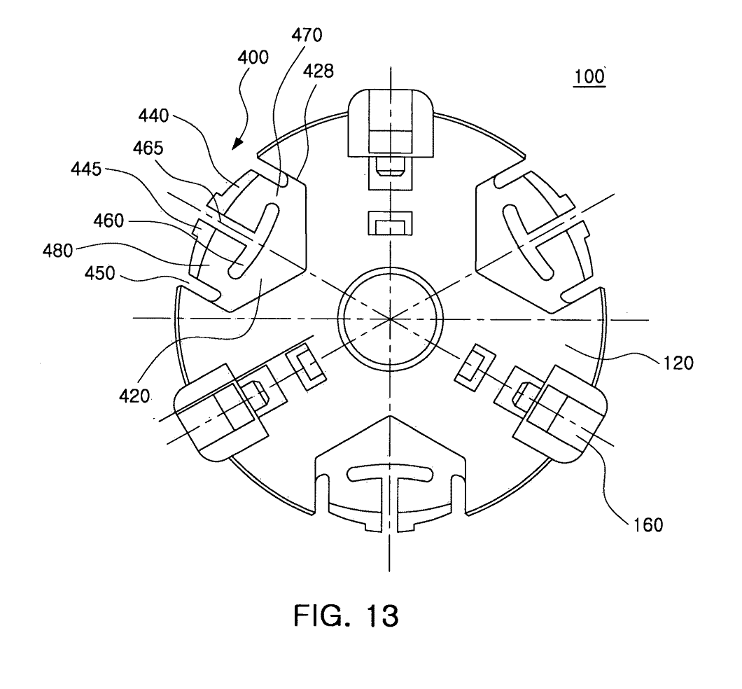

FIG. 11 is a plan view of a disk chucking apparatus according to a third exemplary embodiment of the present invention, FIG. 12 is a plan view illustrating the direction of force applied to a disk by a disk chucking apparatus when the disk is mounted on the disk chucking apparatus of FIG. 11, and FIG. 13 is a plan view of a modified example of FIG. 11.

Referring to FIGS. 11 to 13, the claw 400 of the exemplary embodiment protrudes on a claw forming portion 428 of the centering case 120 and may include a claw body 420 disposed between boundary line holes 450 which are formed in the centering case 120 in parallel.

Further, the claw 400 may include a body cut piece 480 formed by a separation hole 465 which cuts the claw body 420 inwards in an inner-diameter direction in parallel with the boundary line holes 450 and a rotation rack 470 formed by a gap hole 460 which extends from the separation hole 465 and cuts a part of the body cut piece 480 in a direction different from the separation hole 465.

The gap hole 460 may be formed towards the boundary line holes 450 in the separation hole 465. Further, the gap hole 460 may have a curvature in a direction opposite to the curvature of a contact unit 440.

At this time, the claw forming portion 428 may have a polygonal shape inwards in the centering case.

Referring to FIG. 12, when the claw body 420 is constituted by the plurality of body cut pieces 480 (hereinafter, described as two body cut pieces), the body cut pieces 480 rotate towards the inside of the gap hole 460 to generate claw forces Fc1 and Fc2, respectively.

The claw forces Fc1 and Fc2 are calculated by the sum of normal forces N1 and N2 and tangential forces T1 and T2, respectively and the sum of the claw forces Fc1 and Fc2 forms total claw force Fc.

The claw body 420 is constituted by the plurality of body cut pieces 480 to further increase the claw force.

In the exemplary embodiment, it may be modified as shown in FIG. 13. That is, the contact unit 440 may have a lead-end contact portion 445 of which a part protrudes outwardly in an outer-diameter direction on the boundary of the outer peripheral surface 124 of the centering case 120 to contact the inner peripheral surface of the disk D.

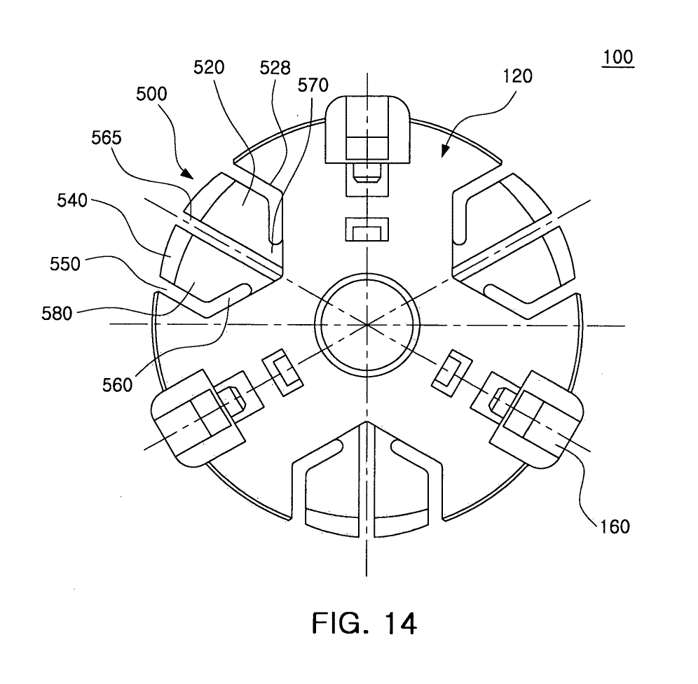

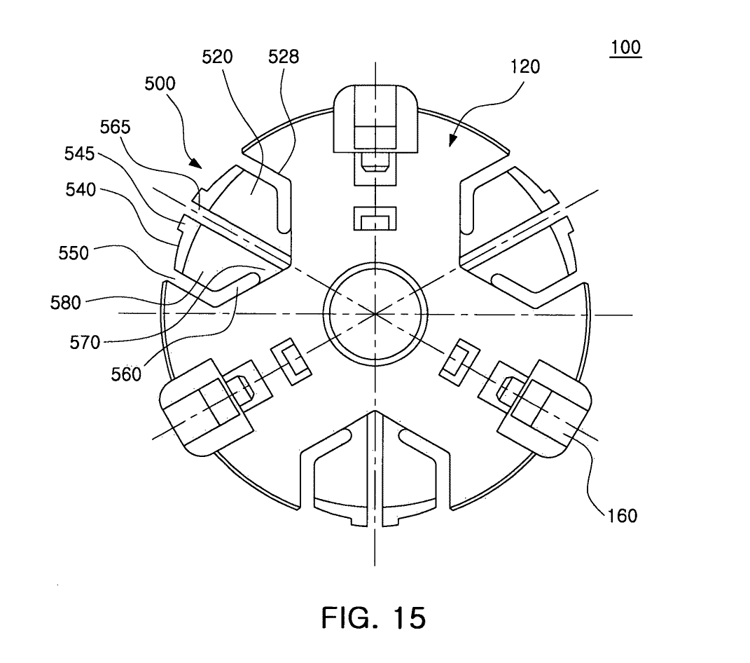

FIG. 14 is a plan view of a disk chucking apparatus according to a fourth exemplary embodiment of the present invention and FIG. 15 is a plan view of a modified example of FIG. 14.

Referring to FIG. 14, the claw 500 of the exemplary embodiment protrudes on a claw forming portion 528 of the centering case 120 and may include a claw body 520 disposed between boundary line holes 550 which are formed in the centering case 120 in parallel.

Further, the claw 500 may include a body cut piece 580 formed by a separation hole 565 which cuts the claw body 520 inwards in an inner-diameter direction in parallel with the boundary line holes 550 and a rotation rack 570 formed by a gap hole 560 which extends from at least one of the boundary line holes 550 and cuts a part of the body cut piece 580 in the direction of the separation hole 565 of the body cut piece 580.

At this time, the claw forming portion 528 may have a polygonal shape inwards in the centering case 120.

The gap hole 560 may be formed along the inner surface the claw forming portion 528.

In the exemplary embodiment, it may be modified as shown in FIG. 15. That is, the contact unit 540 may have a lead-end contact portion 545 of which a part protrudes outwardly in an outer-diameter direction on the boundary of the outer peripheral surface 124 of the centering case 120 to contact the inner peripheral surface of the disk D.

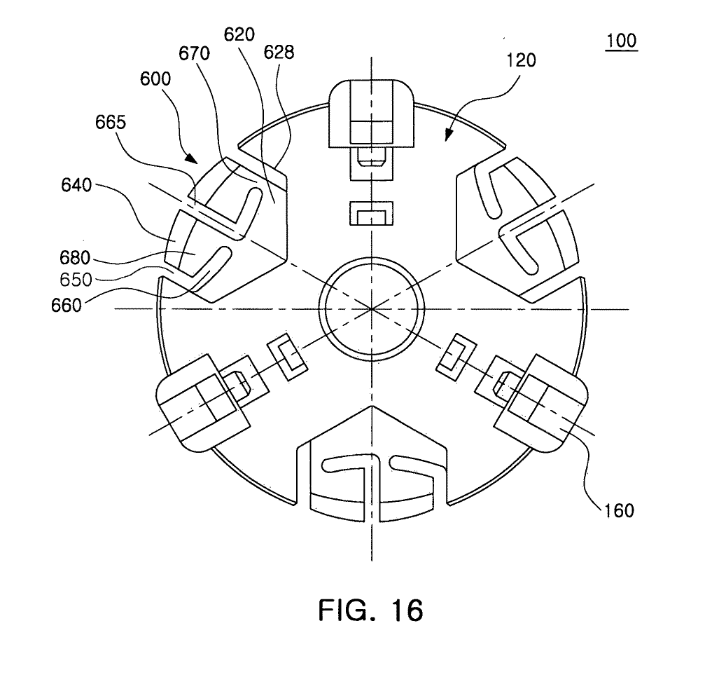

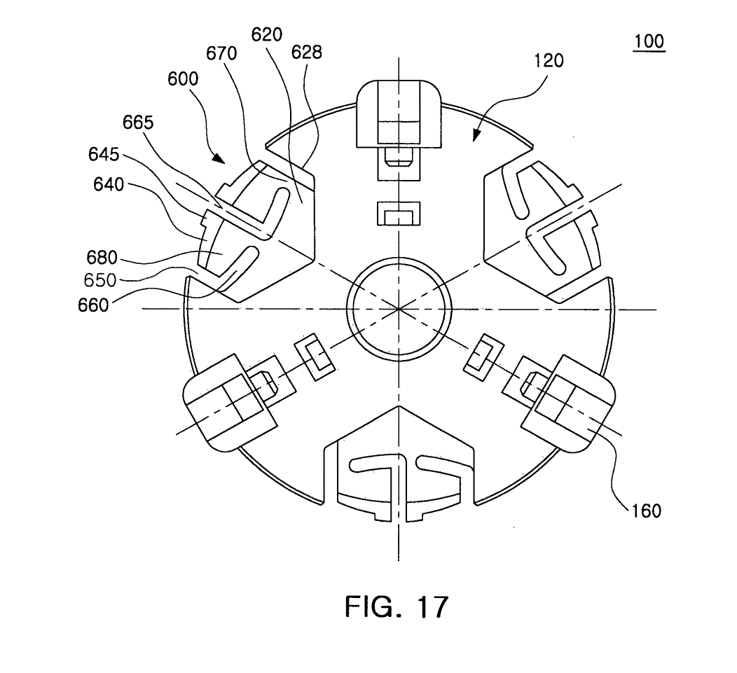

FIG. 16 is a plan view of a disk chucking apparatus according to a fifth exemplary embodiment of the present invention and FIG. 17 is a plan view of a modified example of FIG. 16.

Referring to FIG. 16, the claw 600 of the exemplary embodiment protrudes on a claw forming portion 628 of the centering case 120 and may include a claw body 620 disposed between boundary line holes which are formed in the centering case in parallel.

Further, the claw 600 may include a body cut piece 680 formed by a separation hole 665 which cuts the claw body 620 inwards in an inner-diameter direction in parallel with the boundary line holes 650 and a rotation rack 670 formed by a gap hole 660 which extends from at least one of the boundary line holes 650 and the separation hole 665 and cuts a part of the body cut piece 680 in the direction of the separation hole 665 and another boundary line hole 650.

At this time, the claw forming portion 628 may have a polygonal shape inwards in the centering case 120.

In the exemplary embodiment, it may be modified as shown in FIG. 17. That is, the contact unit 640 may have a lead-end contact portion 645 of which a part protrudes outwardly in an outer-diameter direction on the boundary of the outer peripheral surface 124 of the centering case 120 to contact the inner peripheral surface of the disk D.

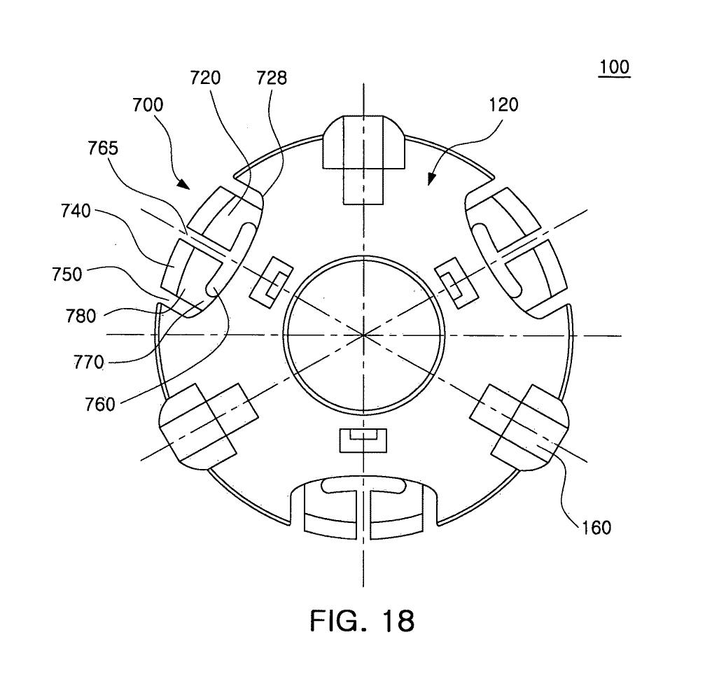

FIG. 18 is a plan view of a disk chucking apparatus according to a sixth exemplary embodiment of the present invention.

Referring to FIG. 18, the claw 700 of the exemplary embodiment protrudes on a claw forming portion 728 of the centering case 120 and may include a claw body 720 disposed between boundary line holes 750 which are formed in the centering case 120 in parallel.

Further, the claw 700 may include a body cut piece 780 formed by a separation hole 765 which cuts the claw body 720 inwards in an inner-diameter direction in parallel with the boundary line holes 750 and a rotation rack 770 formed by a gap hole 760 which extends from at least one of the boundary line holes 750 from the separation hole 765 and cuts space between the claw body forming portion 728 and the body cut piece 780 to separate the claw body forming portion 728 and the body cut piece 780 from each other.

At this time, the gap hole 760 may have a curvature in an opposite direction to the curvature of a contact unit 740. In addition, the inner surface of the centering case 120 of the claw forming portion 728 may have the same shape as the gap hole 760.

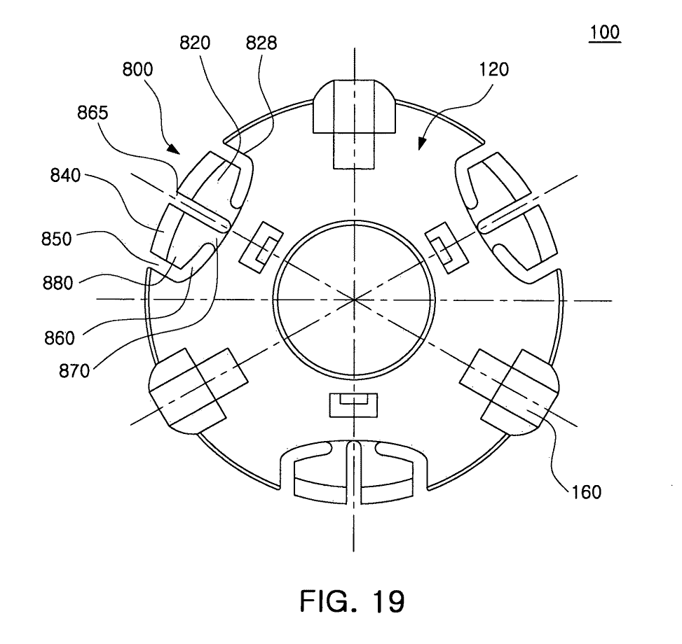

FIG. 19 is a plan view of a disk chucking apparatus according to a seventh exemplary embodiment of the present invention.

Referring to FIG. 19, the claw 800 of the exemplary embodiment protrudes on a claw forming portion 828 of the centering case 120 and may include a claw body 820 disposed between boundary line holes 850 which are formed in the centering case 120 in parallel.

The claw 800 may include a body cut piece 880 formed by a separation hole 865 which cuts the claw body 820 inwards in an inner-diameter direction in parallel with the boundary line holes 850 and a rotation rack 870 formed by a gap hole 860 which extends from at least one of the boundary line holes 850 and cuts a part of the body cut piece 880 in the direction of the separation hole 865 of the body cut piece 880.

At this time, the inner surface of the centering case 120 of the claw forming portion 828 may have the same shape as the gap hole 860. In addition, the gap hole 860 may be formed along the inner surface the claw forming portion 828.

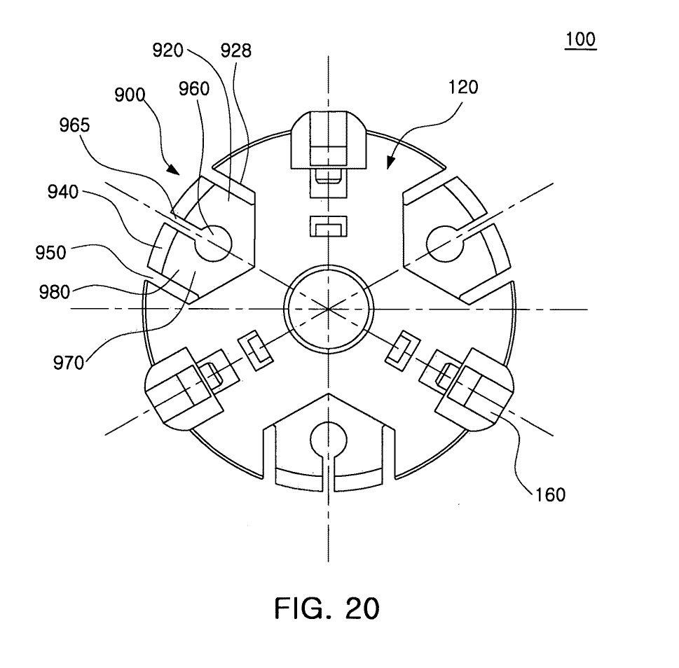

FIG. 20 is a plan view of a disk chucking apparatus according to an eighth exemplary embodiment of the present invention.

Referring to FIG. 20, the claw 900 of the exemplary embodiment protrudes on a claw forming portion 928 of the centering case 120 and may include a claw body 920 disposed between boundary line holes 950 which are formed in the centering case 120 in parallel.

Further, the claw 900 may include a body cut piece 980 formed by a separation hole 965 which cuts the claw body 920 inwards in an inner-diameter direction in parallel with the boundary line holes 950 and a rotation rack formed by a circular gap hole 960 having a diameter larger than the width of the separation hole 965 at an inner-diameter direction end of the separation hole 965.

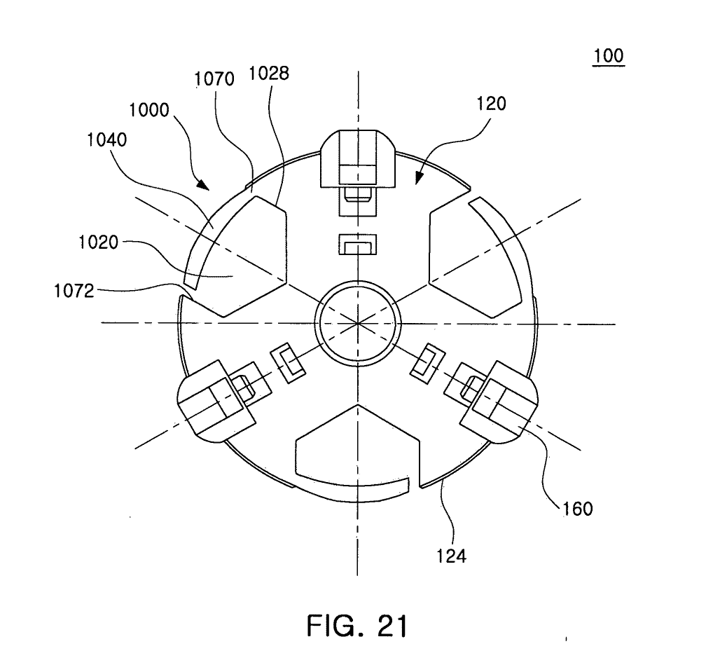

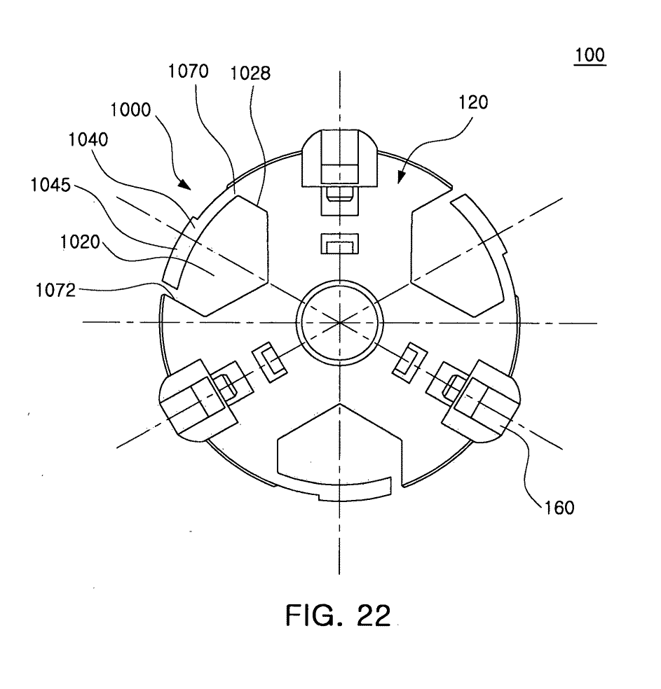

FIG. 21 is a plan view of a disk chucking apparatus according to a ninth exemplary embodiment of the present invention and FIG. 22 is a plan view of a modified example of FIG. 21.

Referring to FIG. 21, the claw 1000 of the exemplary embodiment may include a claw forming portion 1020 configured by space where a contact unit 1040 can be introduced into the centering case 120.

The contact unit 1040 extends to form an outer diameter of the centering case 120 at one end 1070 of the outer periphery 124 of the centering case 120 and may be separated from the other end 1072 of the outer periphery 124 of the centering case 120 corresponding to the one end 1070.

At this time, the claw forming portion 1020 may have a polygonal shape inwards in the centering case 120.

In the exemplary embodiment, it may be modified as shown in FIG. 22. That is, the contact unit 1040 may have a lead-end contact portion 1045 of which a part protrudes outwardly in an outer-diameter direction on the boundary of the outer periphery 124 of the centering case 120 to contact the inner peripheral surface of the disk D.

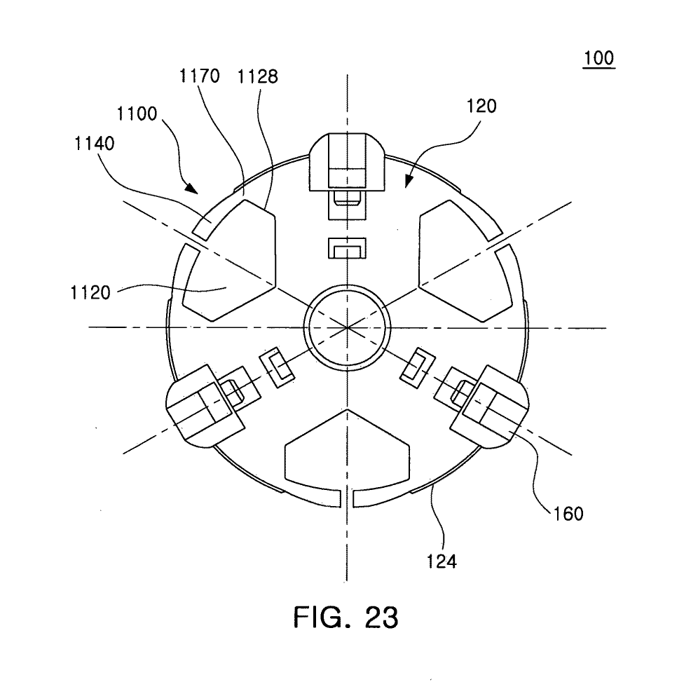

FIG. 23 is a plan view of a disk chucking apparatus according to a tenth exemplary embodiment of the present invention.

Referring to FIG. 23, the claw 1100 of the exemplary embodiment may include a claw forming portion 1120 configured by space where a contact unit 1140 can be introduced into the centering case 120.

The contact unit 1140 extends to form an outer diameter of the centering case 120 at both ends 1170 of the outer periphery 124 of the centering case 120 and may be separated from an end at which the contact units 1140 contact each other.

At this time, the claw forming portion 1120 may have a polygonal shape inwards in the centering case 120.

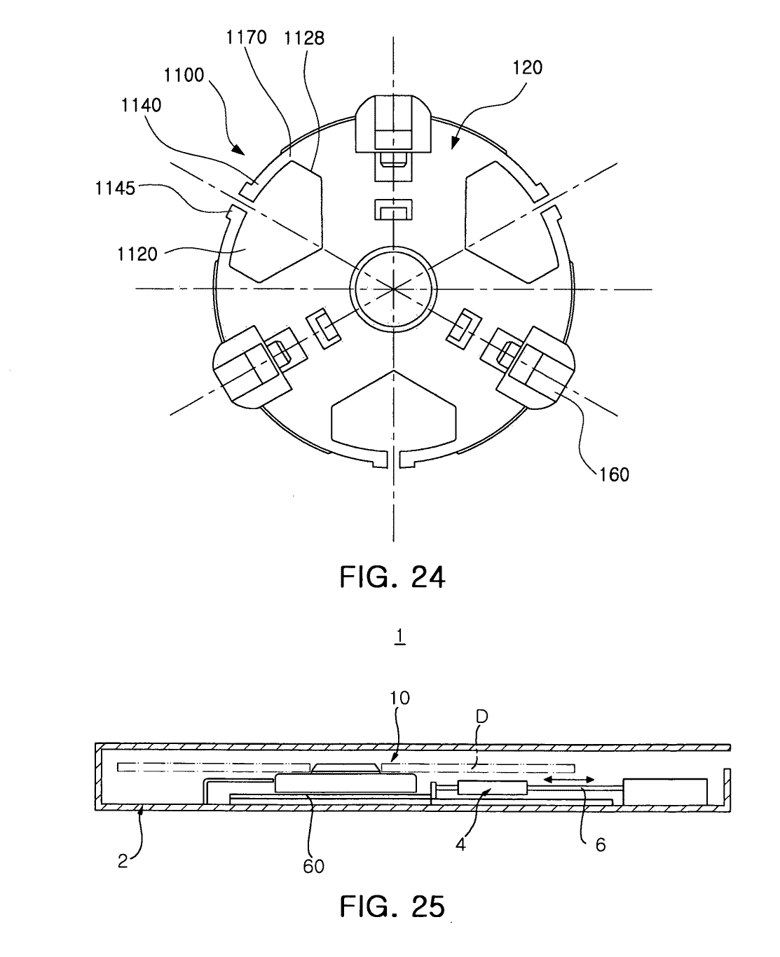

In the exemplary embodiment, it may be modified as shown in FIG. 24. That is, ends where the contact units 1140 contact each other may have a lead-end contact portion 1145 of which a part protrudes outwardly in an outer-diameter direction on the boundary of the outer periphery of the centering case 120 to contact the inner peripheral surface of the disk D.

Disk Driving Device

FIG. 25 is a schematic cross-sectional view of a disk driving device according to an exemplary embodiment of the present invention.

Referring to FIG. 25, the disk driving device according to the exemplary embodiment of the present invention is equipped with a motor 10 having all technical features.

An optical disk driving device 1 according to the exemplary embodiment of the present invention may include a frame 2, optical pick-up mechanism 4, and a transferring mechanism 6.

A base plate 60 on which the motor 10 is mounted may be fixed to the frame 2.

The optical pick-up mechanism 4 may optically record or reproduce a disk D mounted on the motor 10.

The transferring mechanism 6 transfers the optical pick-up mechanism 4 in a diameter direction of the disk D to record information on the entire surface of the disk D or reproduce information.

As set forth above, according to a disk chucking apparatus, a motor, and a disk driving apparatus equipped with the motor according to exemplary embodiments of the present invention, it is possible to prevent stress from concentrating on a claw by reducing force applied by the claw in a direction opposite to a mounting direction of a disk and allowing the claw to elastically support the inner peripheral surface of the disk in a horizontal direction.

Further, since the stress which concentrates on the claw is distributed, it is possible to prevent the claw from being deformed or broken.

Since the claw can apply horizontal force to the inner peripheral surface of the disk, it is possible to prevent the disk mounted on the disk chucking apparatus from slipping or falling out from the centering case.

In addition, since the force applied to the inner peripheral surface of the disk by the claw increases, the center of the disk and the center of the centering case coincide with each other, thereby improving the reliability of the recording or reproducing performance of the disk.

While the present invention has been shown and described in connection with the exemplary embodiments, it will be apparent to those skilled in the art that modifications and variations can be made without departing from the spirit and scope of the invention as defined by the appended claims.

What is claimed is:

1. A disk chucking apparatus, comprising:
a centering case fixed on the inner peripheral surface of a disk; and
a claw formed in the centering case and including a contact unit which rotates in a horizontal direction at the time of mounting the disk and is introduced into the centering case to elastically support the inner peripheral surface of the disk.

2. The disk chucking apparatus of claim 1, wherein the claw includes:
a claw body protruding on a claw forming portion of the centering case and disposed between boundary line holes which are formed in the centering case in parallel; and
a rotation rack formed by a gap hole that extends from one of the boundary line holes and cuts a part of the claw body in a direction different from the direction of the boundary line hole.

3. The disk chucking apparatus of claim 2, wherein the gap hole has a curvature in a direction opposite to the curvature of the contact unit.

4. The disk chucking apparatus of claim 2, wherein the claw is formed on the same level as a planar part of the centering case.

5. The disk chucking apparatus of claim 2, wherein the claw is formed on a level different from the planar part of the centering case.

6. The disk chucking apparatus of claim 2, wherein the claw forming portion has a polygonal shape inwards in the centering case.

7. The disk chucking apparatus of claim 1, wherein the claw includes:
a claw body protruding on the claw forming portion of the centering case and disposed between boundary line holes which are formed in the centering case in parallel; and
a rotation rack formed by a gap hole which extends from one of the boundary line holes and cuts space between the claw forming portion and the claw body to separate the claw body from the claw forming portion.

8. The disk chucking apparatus of claim 7, wherein the gap hole has a curvature in a direction opposite to the curvature of the contact unit.

9. The disk chucking apparatus of claim 7, wherein the inner surface of the centering case of the claw forming portion has the same shape as the gap hole.

10. The disk chucking apparatus of claim 7, wherein the contact unit includes a lead end contact portion of which a part protrudes outwardly in an outer-diameter direction on the boundary of the outer periphery of the centering case to contact the inner peripheral surface of the disk.

11. The disk chucking apparatus of claim 7, wherein the claw body is formed on a plane different from the planar part of the centering case,
the contact unit includes the outer periphery which contacts the inner peripheral surface of the disk at the time of mounting the disk, a lead end which initially contacts the inner peripheral surface of the disk at the time of mounting the disk, and a connection portion which connects the outer periphery with the lead end, and
the curvature of the lead end is larger than that of the connection portion.

12. The disk chucking apparatus of claim 1, wherein the claw includes:
a claw body protruding on the claw forming portion of the centering case and disposed between the boundary line holes which are formed in the centering case in parallel;
a body cut piece formed by a separation hole which cuts the claw body inwards in an inner-diameter direction in parallel with the boundary line holes; and
a rotation rack formed by a gap hole which extends from the separation hole and cuts a part of the claw body in a direction different from the separation hole.

13. The disk chucking apparatus of claim 12, wherein the gap hole is formed towards the boundary line holes in the separation hole.

14. The disk chucking apparatus of claim 12, wherein the gap hole has a curvature in a direction opposite to the curvature of the contact unit.

15. The disk chucking apparatus of claim 12, wherein the claw forming portion has a polygonal shape inwards in the centering case.

16. The disk chucking apparatus of claim 12, wherein the contact unit includes a lead end contact portion of which a part protrudes outwardly in an outer-diameter direction on the boundary of the outer peripheral surface of the centering case to contact the inner peripheral surface of the disk.

17. The disk chucking apparatus of claim 1, wherein the claw includes:
a claw body protruding on the claw forming portion of the centering case and disposed between the boundary line holes which are formed in the centering case in parallel;
a body cut piece formed by a separation hole which cuts the claw body inwards in an inner-diameter direction in parallel with the boundary line hole; and
a rotation rack formed by a separation hole which extends from at least one of the boundary line holes and cuts a part of the claw body in the direction of the separation hole of the body cut piece.

18. The disk chucking apparatus of claim 17, wherein the claw forming portion has a polygonal shape inwards in the centering case.

19. The disk chucking apparatus of claim 17, wherein the gap hole is formed along the inner surface of the claw forming portion.

20. The disk chucking apparatus of claim 17, wherein the contact unit includes a lead end contact portion of which a part protrudes outwardly in an outer-diameter direction on the boundary of the outer peripheral surface of the centering case to contact the inner peripheral surface of the disk.

21. The disk chucking apparatus of claim 1, wherein the claw includes:
a claw body protruding on the claw forming portion of the centering case and disposed between the boundary line holes which are formed in the centering case in parallel;
a body cut piece formed by a separation hole which cuts the claw body inwards in an inner-diameter direction in parallel with the boundary line hole; and
a rotation rack formed by a gap hole which extends from at least one of the boundary line holes and the separation hole and cuts a part of the claw body in the direction of the separation hole and another boundary line hole.

22. The disk chucking apparatus of claim 21, wherein the claw forming portion has a polygonal shape inwards in the centering case.

23. The disk chucking apparatus of claim 21, wherein the contact unit includes a lead end contact portion of which a part protrudes outwardly in an outer-diameter direction on the boundary of the outer peripheral surface of the centering case to contact the inner peripheral surface of the disk.

24. The disk chucking apparatus of claim 1, wherein the claw includes:
a claw body protruding on the claw forming portion of the centering case and disposed between the boundary line holes which are formed in the centering case in parallel;
a body cut piece formed by a separation hole which cuts the claw body inwards in an inner-diameter direction in parallel with the boundary line hole; and
a rotation rack formed by a gap hole which extends towards one of the boundary line holes in the separation hole and cuts space between the claw forming portion and the claw body to separate the claw body from the claw forming portion.

25. The disk chucking apparatus of claim 24, wherein the gap hole has a curvature in a direction opposite to the curvature of the contact unit.

26. The disk chucking apparatus of claim 24, wherein the inner surface of the centering case of the claw forming portion has the same shape as the gap hole.

27. The disk chucking apparatus of claim 1, wherein the claw includes:
a claw body protruding on the claw forming portion of the centering case and disposed between the boundary line holes which are formed in the centering case in parallel;
a body cut piece formed by a separation hole which cuts the claw body inwards in an inner-diameter direction in parallel with the boundary line holes; and
a rotation rack formed by a separation hole which extends from at least one of the boundary line holes and cuts a part of the claw body in the direction of the separation hole of the body cut piece.

28. The disk chucking apparatus of claim 27, wherein the inner surface of the centering case of the claw forming portion has the same shape as the gap hole.

29. The disk chucking apparatus of claim 27, wherein the gap hole is formed along the inner surface of the claw forming portion.

30. The disk chucking apparatus of claim 1, wherein the claw includes:
a claw body protruding on the claw forming portion and disposed between the boundary line holes which are formed in the centering case in parallel;
a body cut piece formed by a separation hole which cuts the claw body inwards in an inner-diameter direction in parallel with the boundary line hole; and
a rotation rack formed by a circular gap hole having a diameter larger than the width of the separation hole at an inner-diameter direction end of the separation hole.

31. The disk chucking apparatus of claim 1, wherein the claw includes a claw forming portion configured by space where the contact unit is introduced into the centering case, and
the contact unit extends to form an outer diameter of the centering case at one end of the outer periphery of the centering case and is separated from the other end of the outer periphery of the centering case corresponding to the one end.

32. The disk chucking apparatus of claim 31, wherein the claw forming portion has a polygonal shape inwards in the centering case.

33. The disk chucking apparatus of claim 31, wherein the contact unit includes a lead end contact portion of which a part protrudes outwardly in an outer-diameter direction on the boundary of the outer periphery of the centering case to contact the inner peripheral surface of the disk.

34. The disk chucking apparatus of claim 1, wherein the claw includes a claw forming portion configured by space where the contact unit is introduced into the centering case, and
the contact unit extends to form an outer diameter of the centering case at both ends of the outer periphery of the centering case and the ends at which the contact units contact each other are separated from each other.

35. The disk chucking apparatus of claim 34, wherein the claw forming portion has a polygonal shape inwards in the centering case.

36. The disk chucking apparatus of claim 34, wherein the ends at which the contact units contact each other include a lead end contact portion which partially protrudes outwardly in an outer-diameter direction on the boundary of the outer periphery of the centering case and contacts the inner peripheral surface of the disk.

37. The disk chucking apparatus of claim 1, further comprising:
a chuck chip receiving unit formed on the outer periphery of the centering case and receiving a chuck chip partially protruding outwardly in an outer-diameter direction; and
a boundary wall protruding downwards in the axial direction on the bottom of the centering case to allow the chuck chip receiving unit which is recessed to form a boundary.

38. The disk chucking apparatus of claim 37, wherein the claw is spaced apart from the chuck chip receiving unit with the boundary wall therebetween and protrudes on a claw forming portion having the shape of the boundary wall.

39. The disk chucking apparatus of claim 37, wherein the centering case is disposed on an axial upper part of the rotor case and includes a guide boss where a boss hole in which the outer peripheral surface of a rotor hub of the rotor case press-fits is formed.

40. The disk chucking apparatus of claim 39, wherein the guide boss protrudes towards the chuck chip receiving unit and includes a boss frame where a fastening protrusion to which an elastic member elastically coupled with the chuck chip is fastened is formed.

41. A motor, comprising:
a disk chucking apparatus of claim 1;
a rotor on which the disk chucking apparatus is seated; and
a stator rotatably supporting a shaft which interworks with the rotor.

42. A disk driving device, comprising:
a motor of claim 41 on which a disk is mounted;
a frame equipped with the motor;
an optical pick-up mechanism optically recording or reproducing the disk; and
a transferring mechanism transferring the optical pick-up mechanism in a diameter direction of the disk.
